(19) United States
(12) Patent Application Publication
(10) Pub. No.: US 2011/0029382 A1
(43) Pub. Date: Feb. 3, 2011

(54) Automated Targeting of Information to a Website Visitor

(75) Inventors: Akshay Narasimhan, Los Altos Hills, CA (US); Ashok Narasimhan, Los Altos Hills, CA (US); Roger Applewhite, Palos Verdes Estates, CA (US); Robert Berger, Saratoga, CA (US); Amit Rathore, Burlingame, CA (US); Heather Dawson, Redwood City, CA (US)

Correspondence Address: Law Office of Brian Short, P.O. Box 641867, San Jose, CA, 95164-1867, US

(73) Assignee: RUNU, INC., Mountain View, CA (US)

(21) Appl. No.: 12/843,360

(22) Filed: Jul. 26, 2010

Related U.S. Application Data
(60) Provisional application No. 61/273,056, filed on Jul. 30, 2009.

(51) Int. Cl. G06Q 30/00

(52) U.S. Cl. 705/14.52

(57) ABSTRACT

Embodiments for targeting information to a website visitor are disclosed. One method includes collecting behavioral data of a plurality of users from a plurality of websites. The collected behavioral data is analyzed. For this embodiment, analyzing the collected behavior data includes clustering the collected behavioral data according to behavioral factors wherein collected behavioral data within each cluster include at least one common statistic, and collected behavioral data of different clusters have at least one differentiating statistic. Further, a server collects present user data while a present user is visiting a target website. The present user data is matched with at least one of the clusters of behavior factors based on a comparative analysis of the present user data with the clustered behavior factors. While the present user is still visiting the present website, targeted information is generated and displayed to the present user based on the at least one clustered behavior factor matched to the present user data.

### RELATED APPLICATIONS

This patent application claims priority to U.S. provisional patent application Ser. No. 61/273,056 filed on Jul. 30, 2009 which is incorporated by reference.

### FIELD OF THE DESCRIBED EMBODIMENTS

The described embodiments relate generally to providing information to a potential customer. More particularly, the described embodiments relate to providing automated targeted information to a website visitor.

### BACKGROUND

Online shopping is continually increasing in popularity and has evolved with the growth in technology. Many consumers visit online shopping websites to compare product features and their prices. However, the percentage of online consumers who actually buy a product after viewing it online is very low. An online consumer is mainly influenced by the sales price offered for a particular product. In cases where the sales price offered is appropriate, the online consumer will end up buying the product online.

In order to efficiently use the consumer behavior data, a number of price optimization techniques have been developed. The techniques consider various consumer behavior factors such as time spent on a website, type of products browsed, etc., to provide a consumer with an incentivized pricing scheme. However, most of the price optimization techniques suffer from one or more limitations.

One limitation of existing price optimization techniques is the low conversion ratio of consumers visiting the website to consumers making an online purchase through the website. Further, another limitation of the existing price optimization techniques is to monitor consumer behavior on a large scale across a large number of websites and merchant types. Monitoring consumer behavior on a large scale requires deployment of an extensive hardware and software infrastructure.

There is a need for a method, and a system for optimizing information provided to different consumers based on the stage of the product purchase cycle a consumer is in. Further, there exists a need for providing an optimum pricing mechanism for a merchant that is based on present consumer behavior and predetermined past customer behavior.

### SUMMARY

An embodiment includes a method of targeting information to a website visitor. The method includes collecting behavioral data of a plurality of users from a plurality of websites. The collected behavioral data is analyzed. Analyzing the collected behavior data includes clustering the collected behavioral data according to behavioral factors wherein collected behavioral data within each cluster include at least one common statistic, and collected behavioral data of different clusters have at least one differentiating statistic. Further, a server collects present user data while a present user is visiting a target website. The present user data is matched with at least one of the clusters of behavior factors based on a comparative analysis of the present user data with the clustered behavior factors. While the present user is still visiting the present website, targeted information is generated and displayed to the present user based on the at least one clustered behavior factor matched to the present user data.

Another embodiment includes another method of providing real-time targeted information to a consumer. For this embodiment, past actions of the consumer are detected, wherein the past actions include actions of the consumer before detecting that the consumer has accessed a merchant website. Present actions of the consumer are detected, wherein present actions comprise actions by the consumer during a present merchant website session. A response of the consumer to targeted information is predicted based on a comparative analysis of the past actions and present actions with analytics data. The targeted information is provided to the consumer.

Another embodiment includes a method of providing real-time targeted economic value information to a consumer. The method includes detecting past actions of the consumer, wherein the past actions include actions of the consumer before detecting that the consumer has accessed a merchant website. Present actions of the consumer are detected, wherein present actions include actions by the consumer during a present merchant website session. A response of the consumer to targeted economic value information is predicted based on a comparative analysis of the past actions and present actions with analytics data, wherein the targeted economic value information relates to at least one specific merchant product and to the present merchant website session. The targeted economic value information is provided to the consumer in real-time during the present merchant website session.

Other aspects and advantages of the described embodiments will become apparent from the following detailed description, taken in conjunction with the accompanying drawings, illustrating by way of example the principles of the described embodiments.

### BRIEF DESCRIPTION OF THE DRAWINGS

FIG. 1 shows an example of system for collecting and analyzing behavioral data of a plurality of users from a plurality of websites.

FIG. 2 shows an example of system for matching the present user data with at least one of the different clusters of behavior factors, and while the present user is still visiting the present website, generating and displaying targeted information to the present user.

FIG. 3 is a flow chart that includes steps of one example of a method of targeting information to a website visitor.

FIG. 4 is a flow chart that includes steps of a method of providing real-time targeted information to a consumer.

FIG. 5 is a flow chart that includes the steps of an example of a method of providing real-time targeted economic value information to a consumer.

FIG. 6 shows a computing architecture in which the described embodiments can be implemented.

### DETAILED DESCRIPTION

The embodiments described include methods and apparatuses for providing automated, real-time information targeted to a website visitor. For one embodiment, this includes providing price discounts in real time based on consumer characteristics to increase the conversion ratio of online consumers visiting a merchant's website to online consumers making a purchase on the website.

Typically, online consumers leave a merchant's website after viewing the product details web page. Some consumers may add a product to their shopping cart, but later discontinue the purchase of the product in the shopping cart. However, a consumer who has added a product to the shopping cart is more likely to purchase the product than the consumer who has simply viewed the product details web page. Such consumer behavioral data of those who added a product to their shopping cart, if collected, can be used for various purposes such as setting the sale price or offering discounts on the sale price of a product.

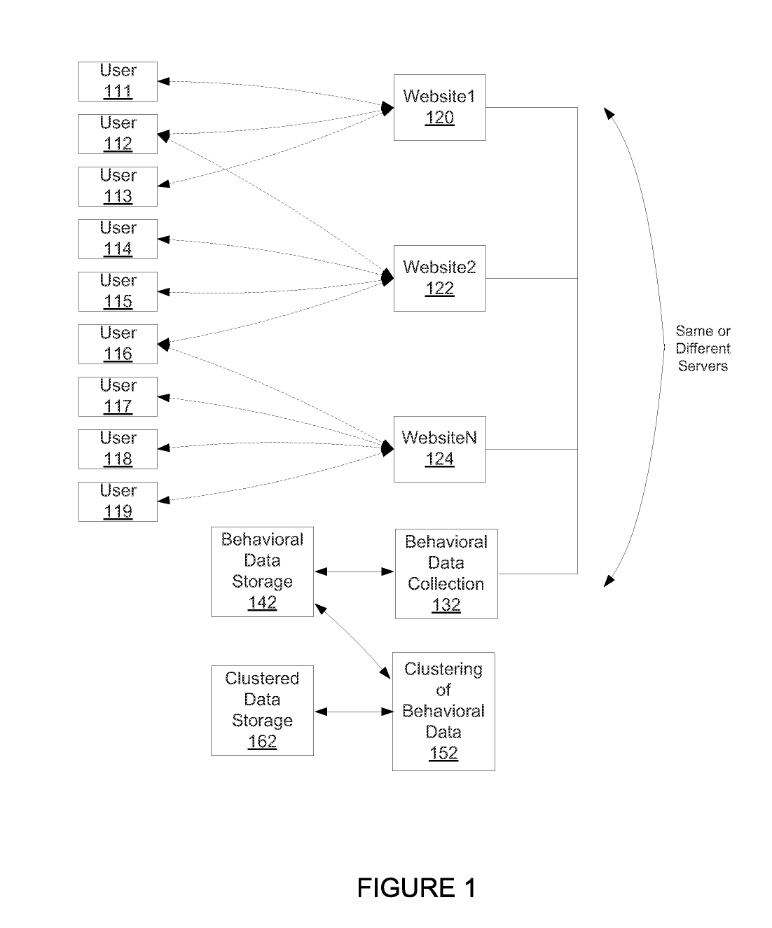

FIG. 1 shows an example of system for collecting and analyzing behavioral data of a plurality of users from a plurality of websites. As shown, exemplary users 111-119 visit websites 120, 122, 124. The actions of the users 111-119 as they visit the websites 120, 122, 124 can be monitored and collected. More specifically, behavioral data of the users 111-119 can be collected from the websites 120, 122, 124 by monitoring the websites 120, 122, 124 and collecting the data about the users.

As shown, a server 132 (which is either a separate server or a common server of at least one of the websites) collects the behavior data which is then stored (storage 142). For an embodiment, the collected data includes actions of the visiting users before arriving at the merchant website, actions taken on the merchant website such as which pages were viewed, in what order and any products placed into a shopping cart and purchases subsequently made by the visiting users.

The collected data can include, for example, pre-click information, checkout status and/or post-click information. A non-exhaustive exemplary list of pre-click information includes a referral URL (Universal Resource Locator), search (such as, search, number of search terms, specific search terms, specific search phrases), banner advertisements (such as, advertisement context, referrer domain, second referrer domain), comparison engine (such as, number of search terms, specific search terms, specific search phrases, comparison page context, customer entered zip code), referrer domain, referrer page contents (such as, shopping comparison site), customer information (such as, return customer, characterizing history data), customer location (such as, time zone, location, demographics, weather, merchant shipping costs). A non-exhaustive exemplary list of check out status includes adding to cart, viewing cart and/or checkout. A non-exhaustive exemplary list of post-click information includes path/actions through site, products viewed, browsing pattern, time on site, cart contents (such as, products, product groups, value, abandonment), current location in funnel, day of week, special day and/or price modifications already applied.

A server 152 (which is either a separate server or a common server of at least one of the websites or the server 132) analyzes the collected behavior data. The analyzing can include clustering the collected behavioral data, which for an embodiment, includes segmenting the collected behavioral data into behavioral factors according to statistically related action of a plurality of users, wherein the segmented behavioral factors can be used to predict future behavior of the plurality of users. The clustered collected behavioral data can be stored in clustered data storage 162 for future access.

For example, the collected behavioral data may indicate, through statistical analysis, that visiting users who view certain pages of a website, such as those describing a tennis racket, are more likely to purchase certain products (such as tennis balls) if offered at a certain discount, than those who do not view those pages.

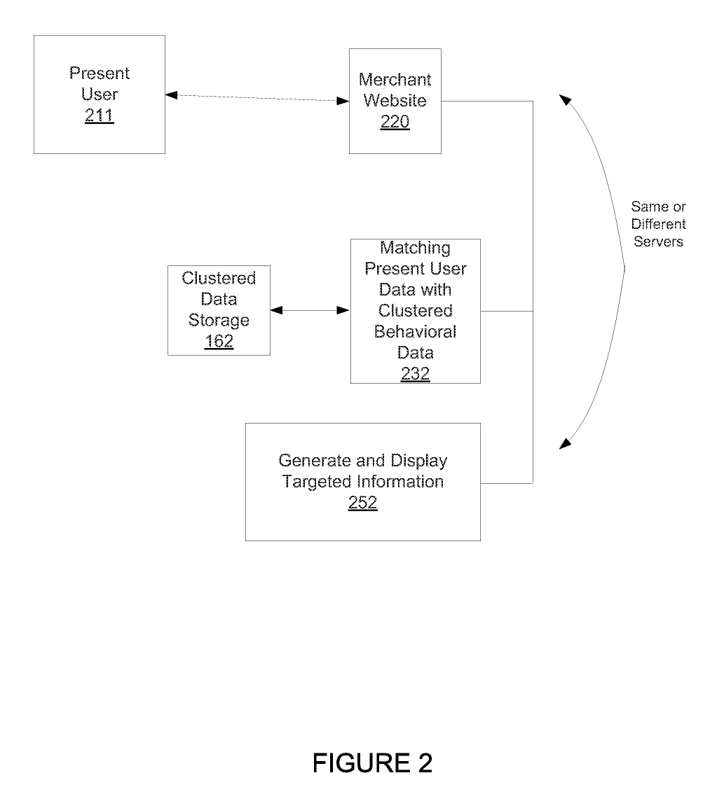

FIG. 2 shows an example of system for matching the present user data with at least one of the clusters of behavior factors, and while the present user is still visiting the present website, generating and displaying targeted information to the present user. A present user 211 accesses a merchant website 220. A server 232 (either a separate server or a common server as the website 220, or other described servers) executes a matching of the present user data with at least one of the clusters of behavior factors. For an embodiment, the matching is based on a comparative analysis of the present user data with the clustered behavior factors of the clustered data base 162. For an embodiment, the comparative analysis includes identifying correlations between the present user data and each of the clustered behavior factors, and identifying which of the clustered behavior factor is most correlated to the present user data, thereby identifying a match between the present user data and the at least one cluster of behavior factors.

For example, the present user loads pages from the website that describe tennis rackets. Contemporaneous to the load, the server 132 collects data describing the pages being loaded and matches the data to one or more segments in the clustered behavioral data of server 232 and clustered data base 162, thus identifying the present user as likely to purchase tennis balls if offered at a certain discount. The process of matching data occurs in an elapsed time short enough such that actions subsequently motivated by the match can be made without the present user being aware that such time has elapsed and before the present user can perform another action, such as leaving the website.

Existing methods of matching user data to behavioral segments cannot effect the match in a manner timely enough not to be noticed by users or to allow the system to take actions to affect user behavior before the user takes actions that preclude it, such as leaving the website.

A server 252 (a separate server or shared with one of the described servers) provides targeted information based upon the matching.

For example, the completed match for present users who view pages describing tennis rackets may indicate that these users should be offered a discount on tennis balls, and further, that such discount should be of a particular size (amount) to optimize the overall profit gained by the merchant.

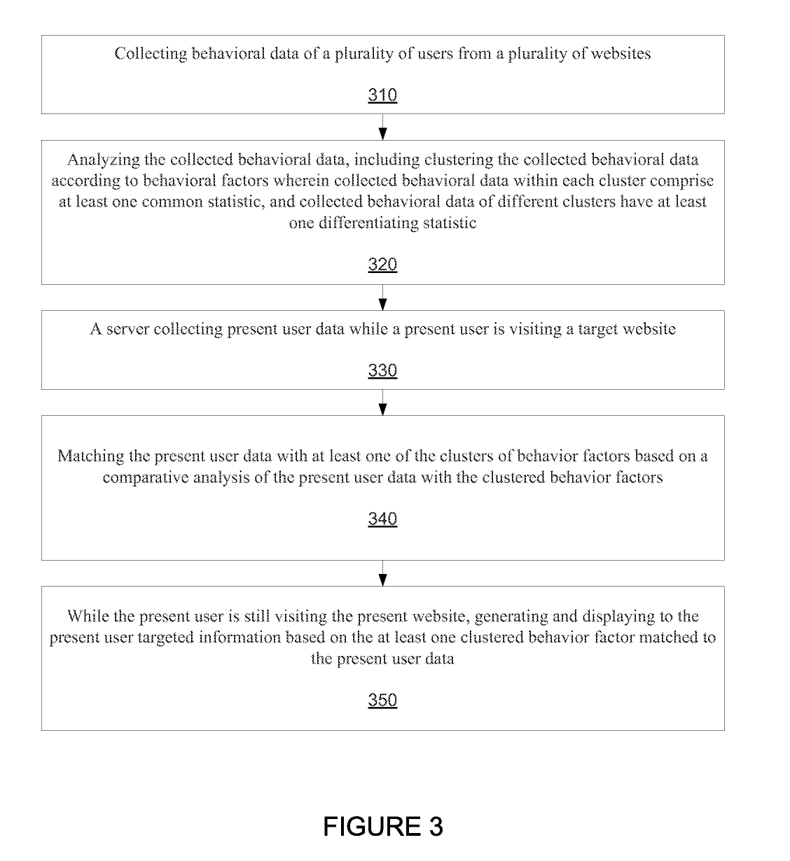

FIG. 3 is a flow chart that includes steps of one example of a method of targeting information to a website visitor. A first step 310 includes collecting behavioral data of a plurality of users from a plurality of websites. A second step 320 includes analyzing the collected behavioral data, including clustering the collected behavioral data according to behavioral factors, wherein collected behavioral data within each cluster include at least one common statistic, and collected behavioral data of different clusters have at least one differentiating statistic. A third step 330 includes a server collecting present user data while a present user is visiting a target website. A fourth step 340 includes matching the present user data with at least one of the clusters of behavior factors based on a comparative analysis of the present user data with the clustered behavior factors. A fifth step 350 includes while the present user is still visiting the present website, generating and displaying to the present user targeted information based on the at least one clustered behavior factor matched to the present user data.

For an embodiment, collecting behavioral data of a plurality of users from a plurality of websites includes monitoring merchant websites and collecting data about users that visit the merchant websites. The collected data includes, for example, actions of the visiting users before arriving at the merchant website, actions taken on the merchant website such as which pages were viewed in what order and any products placed into a shopping cart and purchases subsequently made by the visiting users.

For an embodiment, clustering the collected behavioral data includes segmenting the collected behavioral data into behavioral factors according to statistically related actions of a plurality of users, wherein the segmented behavioral factors can be used to predict future behavior of the plurality of users.

For an embodiment, matching the present user data with at least one of the clusters of behavior factors based on a comparative analysis of the present user data with the clustered behavior factors includes identifying correlations between the present user data and each of the clustered behavior factors, and identifying which of the clustered behavior factor is most correlated to the present user data, thereby identifying a match between the present user data and the at least one cluster of behavior factors. The identified correlation can include, for example, at least one of timing of user actions, and history of the user. The timing of user actions can include, for example, at least one of timing of elapsed time between the user's appearance on the present website and first carting, or timing between visits by the user to the present website. The history of the user can include at least one of information of whether the user was directed to the present website through a search service, whether the user was directed to the present website through a comparison shopping service, the user's order of website page browsing, search terms used by the user to arrive at the present website, attributes of a referring website.

For another embodiment, the identified correlations include at least one of a computer type (for example, Macintosh® versus PC) of the user, an operating system type (such as, Windows® versus Unix) of the user, a browser type of the user (for example, Explorer® versus Netscape), or a location (for example, latitude and longitude) of the user.

For an embodiment, displaying of the present user targeted information to the present user is conditioned on the present user attempting to leave the present website. This particular point in the user's website visit can be a particularly opportune time to offer, for example, a discount that will prompt a transaction to actually occur.

For an embodiment, the targeted information is additionally based on product information of competitive merchant products. The product information can be obtained, for example, by determining past search terms used by the present user, running a real-time search during the present user's session, determining competitive merchants based on search results of the real-time search. By analyzing the prices offered by the competitors, a comparative analysis of the prices offered by all the players, including the competitors and the merchant can be performed. Typically, a consumer is directed to a merchant's webpage through a search engine. The search terms are included in the referral URL, which has directed the consumer to the merchant's webpage. Search terms used by the consumer can be identified based on the URL parameters in the merchant's webpage passed on by the search engine. Those search terms can be entered at the search website to download the search results page, and store the results for an offline analysis.

During an offline analysis, pricing of similar products offered by competitors, which have been provided by the search engine, are identified. Competitor data can be aggregated in search results such as the price data of the competitor products, or merchant data listed in the search results page. The competitor data is related with the consumer's behavior on the merchant's website. A “quality score” for the search results page produced can be calculated from search terms. The quality score is determined by ascertaining a Click Through Rate (CTR) of a user on the merchant's website among the search results. CTR is obtained by dividing the number of users who clicked on a link by the number of times the link was delivered. A server can then provide feedback to the merchant on the performance of activities in search engine optimization and Search Engine Marketing (SEM) such as buying keywords from SEM vendors such as Google® AdWords, Yahoo!® Search Marketing and Microsoft® adCenter. Search engine optimization is a process of enhancing the volume of web-traffic from a search engine to a merchant's site. Competitors' product prices can be compared to the merchant's product prices. This analytic data can be provided to the merchant for price optimization.

An embodiment includes collecting (obtaining) additional information of a customer by using a JavaScript program on the merchant website. The JavaScript program in real time identifies the consumer based on the cookies in the consumer's browser, and the program stores a real-time feed of the consumer's behavior.

First-party cookies can be dropped by the merchant's website onto the consumer's browser, which may be used for tracking the consumer across all of the merchants serviced by the automated price optimization service. When a consumer visits a merchant's website, the JavaScript program opens a first IFrame within the merchant's webpage. The first IFrame corresponds to a web page hosted on a server. The first IFrame searches for a first-party cookie belonging to the server and including identification information of a consumer. If the consumer is new and no earlier first-party cookie is identified, a new first-party cookie is dropped on the consumer's browser. The first IFrame then launches a second hidden IFrame hosted on the merchant's server. The consumer identification information is passed on to the second IFrame as parameters within the Uniform Resource Locator (URL) of the second hidden IFrame. The second hidden IFrame then stores the consumer identification information in a new or existing first-party cookie corresponding to the merchant's website. Thereafter, the consumer identification information is passed from a cookie corresponding to a cookie corresponding to any other merchants' website. Therefore, the consumer is tracked on any merchant's website, even if the consumer has disabled or blocked third-party cookies on his/her browser.

The JavaScript program also gathers consumer behavioral information, such as shopping data before purchase and after purchase, prices offered, and purchase history, and stores it in database for an offline analysis. Consumers are identified by using cookies on their browsers. The JavaScript program runs on the web pages of all the merchants. This helps in gathering consumer behavioral information from multiple merchants' websites.

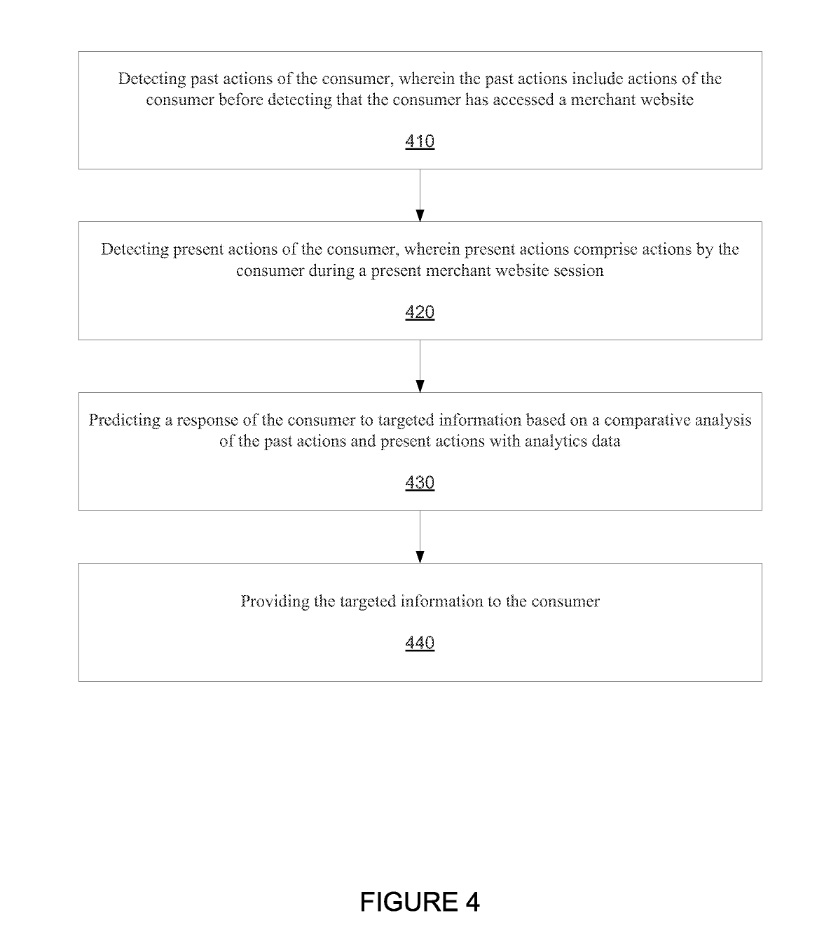

FIG. 4 is a flow chart that includes steps of a method of providing real-time targeted information to a consumer. A first step 410 includes detecting past actions of the consumer, wherein the past actions include actions of the consumer before detecting that the consumer has accessed a merchant website. A second step 420 includes detecting present actions of the consumer, wherein present actions include actions by the consumer during a present merchant website session. A third step 430 includes predicting a response of the consumer to targeted information based on a comparative analysis of the past actions and present actions with analytics data. A fourth step 440 includes providing the targeted information to the consumer.

For an embodiment, the analytic data is collected and analyzed. For example, as previously described, this can include collecting behavioral data of a plurality of users from a plurality of websites. The collected behavioral data is analyzed by clustering the collected behavioral data according to behavioral factors wherein collected behavioral data within each cluster comprise at least one common statistic, and collected behavioral data of different clusters have at least one differentiating statistic.

As previously mentioned, the providing of the targeted information to the consumer can be conditioned upon a determination that the consumer is attempting to leave the merchant website. For an embodiment, providing the targeted information to the consumer includes embedding and integrating the targeted information into the merchant's website.

As previously described, detecting past actions of the consumer can include determining past search terms used by the consumer, running a real-time search during the consumers present session, and determining competitive merchants based on search results of the real-time search. This can further include analyzing product information of the competitive merchants, and generating targeted information based on the analyzed product information.

For an embodiment, the comparative analysis includes generating a demand function for the consumer, wherein the demand function includes consumer characteristics, predetermined merchant rules, competitive information, and/or product type. Prices presented on the merchant's website can be managed based on the demand function. The demand function can be adaptively updated.

For example, a present user that views pages describing tennis rackets, may be willing to purchase tennis balls at a price different from other users who had not viewed such pages. The demand function describes such willingness to buy products, at various prices, depending on the segment or factor a given user was matched to in the Consumer Behavioral Data.

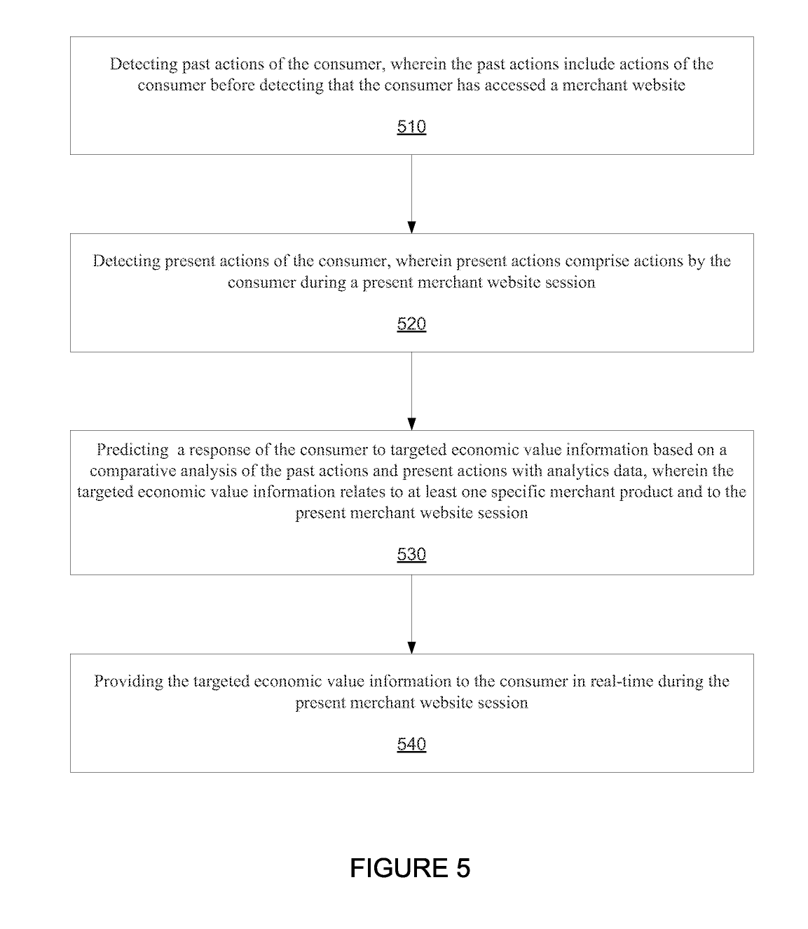

FIG. 5 is a flow chart that includes the steps of an example of a method of providing real-time targeted economic value information to a consumer. A first step 510 includes detecting past actions of the consumer, wherein the past actions include actions of the consumer before detecting that the consumer has accessed a merchant website. A second step 520 includes detecting present actions of the consumer, wherein present actions comprise actions by the consumer during a present merchant website session. A third step 530 includes predicting a response of the consumer to targeted economic value information based on a comparative analysis of the past actions and present actions with analytics data, wherein the targeted economic value information relates to at least one specific merchant product and to the present merchant website session. A fourth step 540 includes providing the targeted economic value information to the consumer in real-time during the present merchant website session.

For an embodiment, the targeted economic value information includes a specific offer of a price for a specific product. However, for other embodiments, the targeted economic value information includes things other than price. For example, an offer of free shipping or a two-for-one offer can additionally or alternatively be provided as examples of targeted economic value information. The targeted economic value information can be provided to the consumer in real-time during the present merchant website session. That is, the information is generated and displayed fast enough that the consumer visiting the merchant's website perceives the displayed information as “real-time”. That is, the consumer cannot observe a noticeable delay. The information is provided while the consumer is still on the merchant's website, and can be triggered, for example, by the consumer exiting a merchant website shopping cart, or attempting to leave the merchant's website without a purchase being completed.

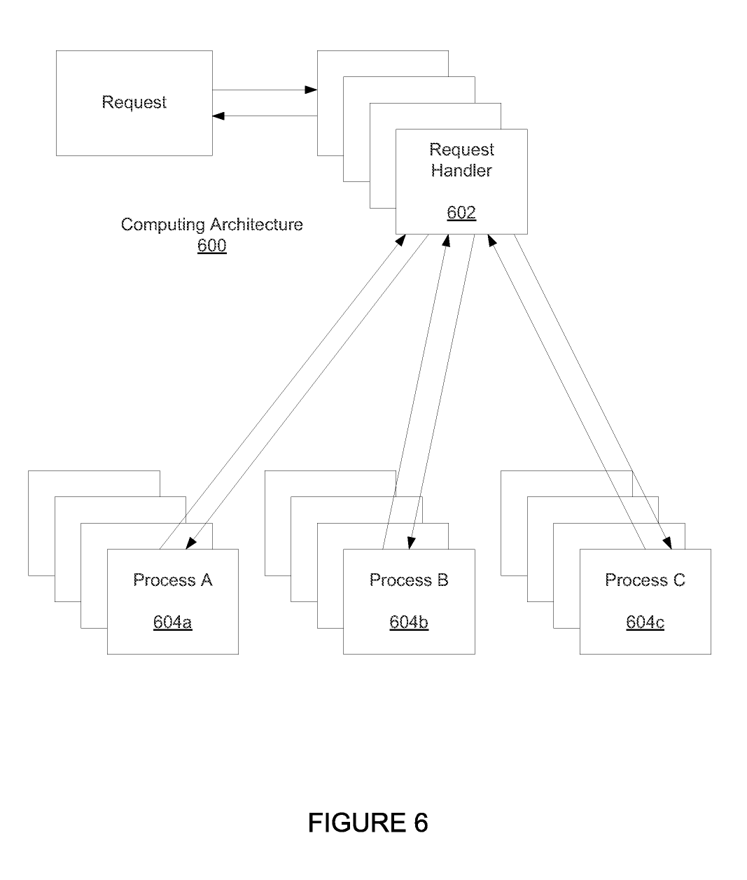

FIG. 6 shows a computing architecture in which the described embodiments can be implemented. For an embodiment, the prediction of the response of the consumer to targeted information is computed on a scalable computing architecture. For an embodiment, the scalable computing architecture includes swarm processing. The computer architecture of FIG. 6 can be particularly useful because it is a highly-scalable, parallel-processing architecture. The computing architecture 600 can be used for implementing the various functions previously described, such as behavioral data collection 132, behavioral data storage 142, clustering of behavioral data 152, clustered data storage 162, matching present user data with clustered behavioral data 232, and/or generating and targeting information 252.

For this embodiment, the computing architecture 600 comprises a request handler 602 and a multiple-processing framework and multiple concurrent processes 604 (604a, 604b, 604c), each such process representing a sub-task of a larger task that the architecture has been directed to complete. The computing architecture 600 can be implemented by a network of computers, such that the request handler 602 can assign any one or a multitude of the concurrent processes to any one or a multitude of networked computers (networked computers that can be communicated with by the computing architecture over available computer networks) for the completion of the task. Therefore, the overall capacity of the computing architecture to complete a task or a multitude of tasks within a certain elapsed time is only limited by the number of networked computers available. As the number of tasks grows, such as may occur by the addition of websites or visiting users, or the requirement for elapsed time to process a task decreases, or both, the computing architecture can successfully meet such requirements by adding additional networked computers, without limit.

For example, an embodiment includes the simultaneous matching being handled by a request handler. The request handler receives multiple requests for matching and assigns any one or a multitude of the requests for matching to any one or a multitude of networked computers (networked computers that can be communicated with by the computing architecture over available computer networks) for the completion of the requests for matching. For another embodiment, clustering the collected behavioral data according to behavioral factors is handled by a request handler. The request handler receives multiple requests for clustering and assigns any one of a multitude of the requests for clustering to any one or a multitude of networked computers for the completion of the requests for clustering.

As a present user loads pages from the website that describe, for example, tennis rackets, contemporaneous to the load, a first server executes the behavioral data collection 132 of data describing the pages being loaded, while a second server executes matching of present user data to one or more segments of clustered behavioral data 232. Embodiments include the first and second servers employing the computing architecture 600 by accepting the task of matching the incoming data of the present user to segments in the Clustered Behavioral Data. For an embodiment, the task of matching is broken down into smaller sub-tasks that are assigned by the request handler 602 to various processes 604 (a, b, c). The request handler 602 subsequently assigns one or more processes 604 (a, b, c) to one or more networked computers. The assignment can be made for optimal speed of completion of each process 604. When all the processes 604 (a, b, c) are complete, the request handler 602 assembles the results of each sub-task from each corresponding processes 604 (a, b, c) into a complete result of the original task, namely that users who view tennis rackets are likely to buy tennis balls when offered a discount of a certain size.

For an embodiment, the request handler 602 includes Swarmiji, and the processes 604a, 604b, 604c include Sevaks. Only three Swarmiji Sevaks 604a, 604b, and 604c are shown for the purpose of illustration. Swarmiji Sevak is a Swarmiji worker process, and it can be easily spawned and coordinated to process real time or static data with a high degree of parallelism. Request handler 602 receives a request for a report or data from a requestor, such as a browser, a pricing engine, or a merchant. Thereafter, request handler 602 dispatches partial requests to Swarmiji Sevaks 604a, 604b, and 604c. Swarmiji Sevaks 604 a, 604b, and 604c complete partial requests and return the report to request handler 602. Request handler 602 then uses these reports to build a consolidated report and sends the report back to the requestor.

Swarmiji is a framework for creating and harnessing swarms of scalable concurrent processes called Swarmiji Sevaks. The framework is primarily written in Clojure on the Java Virtual Machine (JVM), which can utilize libraries from any JVM-compatible language. The framework draws heavily from existing systems such as Erlang, Termite, and the latest Nanite. The framework uses isolated processes to distribute computational load and pass messages to facilitate communication between processes. The framework also includes a management system that handles resource monitoring, process monitoring, etc.

Although specific embodiments have been described and illustrated, the embodiments are not to be limited to the specific forms or arrangements of parts so described and illustrated.

What is claimed:

1. A method of targeting information to a website visitor, comprising:
collecting behavioral data of a plurality of users from a plurality of websites;
analyzing the collected behavioral data, comprising clustering the collected behavioral data according to behavioral factors wherein collected behavioral data within each cluster comprise at least one common statistic, and collected behavioral data of different clusters have at least one differentiating statistic;
a server collecting present user data while a present user is visiting a target website;
matching the present user data with at least one of the clusters of behavior factors based on a comparative analysis of the present user data with the clustered behavior factors; and
while the present user is still visiting the present website, the server generating and displaying to the present user targeted information based on the at least one clustered behavior factor matched to the present user data.

2. The method of claim 1, wherein collecting behavioral data of a plurality of users from a plurality of websites comprises monitoring merchant websites and collecting data about users that visit the merchant website, wherein the collected data includes actions of the visiting users and any products placed into a shopping cart and purchases subsequently made by the visiting users.

3. The method of claim 2, wherein the collected data further includes actions of the visiting users before arriving at the merchant website, actions taken on the merchant website such as which pages were viewed in what order.

4. The method of claim 1, wherein clustering the collected behavioral data comprises segmenting the collected behavioral data into behavioral factors according to statistically related action of a plurality of users, wherein the segmented behavioral factors can be used to predict future behavior of the plurality of users.

5. The method of claim 1, wherein matching the present user data with at least one of the clusters of behavior factors based on a comparative analysis of the present user data with the clustered behavior factors comprises identifying correlations between the present user data and each of the clustered behavior factors, and identifying which of the clustered behavior factor is most correlated to the present user data, thereby identifying a match between the present user data and the at least one cluster of behavior factors.

6. The method of claim 5, wherein the identified correlations include at least one of timing of user actions, and history of the user.

7. The method of claim 6, wherein the timing of user actions comprises at least one of timing of elapsed time between the user's appearance on the present website and first carting, timing between visits by the user to the present website.

8. The method of claim 6, wherein history of the user comprises at least one of information of whether the user was directed to the present website through a search service, whether the user was directed to the present website through a comparison shopping service, the user's order of website page browsing, search terms used by the user to arrive at the present website, attributes of a referring website.

9. The method of claim 5, wherein the identified correlations include at least one a computer type of the user, an operating system type of the user, a browser type of the user, a location of the user.

10. The method of claim 1, further comprising conditioning the displaying of the present user targeted information to the present user upon the present user attempting to leave the present website.

11. The method of claim 1, wherein the targeted information is additionally based on product information of competitive merchant products.

12. The method of claim 11, wherein the product information is obtained by determining past search terms used by the present user, running a real-time search during the present user's session, determining competitive merchants based on search results of the real-time search.

13. A method of providing real-time targeted information to a consumer, comprising:
detecting past actions of the consumer, wherein the past actions include actions of the consumer before detecting that the consumer has accessed a merchant website;
detecting present actions of the consumer, wherein present actions comprise actions by the consumer during a present merchant website session;
predicting a response of the consumer to targeted information based on a comparative analysis of the past actions and present actions with analytics data;
providing the targeted information to the consumer.

14. The method of claim 13, further comprising collecting the analytic data, comprising:
collecting behavioral data of a plurality of users from a plurality of websites;
analyzing the collected behavioral data, comprising clustering the collected behavioral data according to behavioral factors wherein collected behavioral data within each cluster comprise at least one common statistic, and collected behavioral data of different clusters have at least one differentiating statistic.

15. The method of claim 14, further comprising conditioning the providing of the targeted information to the consumer if the consumer attempts to leave the merchant website.

16. The method of claim 14, wherein providing the targeted information to the consumer comprises embedding and integrating the targeted information into the merchant's website.

17. The method of claim 14, wherein predicting a response of the consumer to targeted information based on a comparative analysis of the past actions and present actions with analytics data comprises indentifying correlations between the present and past actions with the analytics data.

18. The method of claim 17, wherein the identified correlations include at least one of timing of user actions, and history of the user.

19. The method of claim 18, wherein the timing of consumer actions comprises at least one of timing of elapsed time between the consumer's appearance on the present website and first carting, timing between visits to the present website.

20. The method of claim 18, wherein history of the user comprises at least one of information of whether the consumer was directed to the present website through a search service, whether the consumer was directed to the present website through a comparison shopping service, the consumer's order of website page browsing, search terms used by the consumer to arrive at the present website, attributes of a referring website.

21. The method of claim 17, wherein the identified correlations include at least one a computer type of the consumer, an operating system type of the consumer, a browser type of the consumer, a location of the consumer.

22. The method of claim 14, wherein detecting past actions of the consumer comprises:
determining past search terms used by the consumer;
running a real-time search during the consumers present session;
determining competitive merchants based on search results of the real-time search.

23. The method of claim 22, further comprising:
analyzing product information of the competitive merchants;
generating targeted information based on the analyzed product information.

24. The method of claim 23, wherein the comparative analysis comprises generating a demand function for the consumer, the demand function comprising consumer characteristics, predetermined merchant rules, competitive information, product type.

25. A computing system for providing real-time targeted information to a consumer, comprising:
a plurality of merchant servers collecting present user data while a plurality of present users are visiting a plurality of merchant websites;
the plurality of merchant servers accessing clusters of behavioral factors from a behavioral database;
simultaneously matching the present user data of each of the plurality of present users with at least one of the clusters of behavior factors based on a comparative analysis of the present user data of each of the plurality of present users with the clustered behavior factors; and
while the plurality of present users are still visiting the plurality of merchant websites, the plurality of merchant servers generating and displaying to each of the plurality of present users targeted information based on the at least one clustered behavior factor matched to the present user data.

26. The computing system of claim 25, wherein the simultaneous matching comprises a request handler receiving multiple requests for matching and assigning any one or a multitude of the requests for matching to any one of a multitude of networked computers for the completion of the requests for matching.

27. The computing system of claim 25, further comprising the merchant server displaying the targeted information to a present user if the present user attempts to leave the merchant website.

28. The computing system of claim 26, further comprising:
at least one server collecting behavioral data of a plurality of users from a plurality of websites;
at least one behavioral data collection server analyzing the collected behavioral data, comprising clustering the collected behavioral data according to behavioral factors wherein collected behavioral data within each cluster comprise at least one common statistic, and collected behavioral data of different clusters have at least one differentiating statistic;
the at least one behavioral data collection server storing the clusters of behavioral factors in the behavioral database.

29. The computing system of claim 28, wherein clustering the collected behavioral data according to behavioral factors comprises a request handler receiving multiple requests for clustering and assigning any one of a multitude of the requests for clustering to any one or a multitude of networked computers for the completion of the requests for clustering.

30. The computing system of claim 28, wherein collecting behavioral data of a plurality of users from a plurality of websites comprises monitoring merchant websites and collecting data about users that visit the merchant website, wherein the collected data includes actions of the visiting users and any products placed into a shopping cart and purchases subsequently made by the visiting users.

31. A method of providing real-time targeted economic value information to a consumer, comprising:
detecting past actions of the consumer, wherein the past actions include actions of the consumer before detecting that the consumer has accessed a merchant website;
detecting present actions of the consumer, wherein present actions comprise actions by the consumer during a present merchant website session;
predicting a response of the consumer to targeted economic value information based on a comparative analysis of the past actions and present actions with analytics data, wherein the targeted economic value information relates to at least one specific merchant product and to the present merchant website session;
providing the targeted economic value information to the consumer in real-time during the present merchant website session.
